(19) United States
(12) Patent Application Publication
(10) Pub. No.: US 2021/0235818 A1
(43) Pub. Date: Aug. 5, 2021

(54) Methods And Devices Of Applying Wax

(71) Applicant: Amir James Dia, Palos Verdes Estates, CA (US)

(72) Inventor: Amir James Dia, Palos Verdes Estates, CA (US)

(21) Appl. No.: 17/150,829

(22) Filed: Jan. 15, 2021

Related U.S. Application Data
(60) Provisional application No. 62/962,797, filed on Jan. 17, 2020.

(51) Int. Cl. A43C 9/00; C08L 91/06

(52) U.S. Cl. CPC A43C 9/00; C08L 91/06

(57) ABSTRACT

Article and method are provided to increase surface friction and gription of shoelaces and bootlaces to prevent untying of the knots of shoelaces and bootlaces and make the surfaces of the shoelaces and bootlaces bitter in taste to deter pets from chewing them. An applicator comprising a wax-based compound formulated from vegetable oils, beeswax, coconut oil and bitter apple extract increases the surface friction and gription of shoelaces and bootlaces as well as make them bitter in taste for pets when applied on the surfaces of the shoelaces and bootlaces. The wax-based compound of the applicator may also function as water and moisture repellant on the surfaces of footwear, garments, and sports equipment in addition to shoe and boot laces under all types of conditions and climates.

### RELATED APPLICATIONS

This application claims priority to U.S. Provisional Application Ser. No. 62/962,797 filed Jan. 17, 2020, entitled WAX APPLICATOR AND METHODS, which is hereby incorporated herein by reference in its entirety.

### FIELD OF THE INVENTION

The present invention relates to a novel wax-based applicator to increase the stiction, the static friction that needs to be overcome to enable relative motion of stationary objects which are in contact with each other, and gription, the property of gripping and providing traction, of the surfaces onto which the wax-based applicator is applied. The present invention also provides a novel wax-based applicator to deter pets from chewing surfaces onto which the wax-based applicator is applied.

### BACKGROUND OF THE INVENTION

Shoelaces becoming untied is a problem everyone has encountered. The knots of the shoelaces may untie while walking or running for a variety of reasons such as forces being transmitted to the knots as the user's foot strikes the ground, the motion of user's leg, etc. These forces cause the knots in the laces to stretch and relax and ultimately untie.

To mitigate the problem of untying the knots of the shoelaces, the surfaces of the shoelaces need to be modified with increased friction. If the friction of the knot surfaces is higher than the aforementioned forces, the shoelaces will not stretch and relax and remain stationary at and around the knots despite the combined impact of these force and motion.

Also, pet owners often notice that the shoelaces or bootlaces are chewed by pets. Making the surfaces of the shoelaces or bootlaces bitter in taste may deter pets from chewing these surfaces.

Hence, there is a need to develop a compound which may increase the stiction and gription on the surfaces of the shoelaces and bootlaces as well as make the shoelaces and bootlaces bitter in taste.

### OBJECTS AND SUMMARY OF THE INVENTION

The present invention relates to a novel wax-based coating compound which provides increased friction on the surfaces of the shoelaces and bootlaces and resolves the problem of premature untying of the knots of the shoelaces and bootlaces.

In some embodiments of the present invention, a handheld applicator for shoelaces comprises: a wax-based compound comprising beeswax, and coconut oil. In some embodiments, wax-based compound further comprises non-organic additives, for examples, carnauba wax and paraffin wax. The wax-based compound of the present invention increases friction on surfaces of the shoelaces.

According to some embodiments, the present invention uses a handheld applicator for shoelaces and bootlaces. The handheld applicator comprises a body comprising an inner chamber, a removable cap attached to a top portion of the body, and a swivel base attached to a bottom portion of the body. The inner chamber of the body further comprises a wax-based compound comprising, beeswax, vegetable oil and bitter apple extract. According to some embodiments, the wax-based compound further comprises cayenne pepper. The wax-based compound provides bitterness to the surfaces of the shoelaces to deter pets from chewing them.

In some embodiments, the present Application describes a method of application of a wax-based applicator on shoelaces to prevent shoelaces from becoming untied and to provide a bitter taste to said shoelaces. The method involves providing a wax-based substance in a hand-held applicator and rubbing said wax-based substance onto surfaces of said shoelaces to form a coating. Next said shoelaces are tied into a knot located at said surfaces, whereby said wax-based substance increases friction and gription of the surfaces of the knot and provides a bitter taste to the shoelaces.

### BRIEF DESCRIPTION OF THE DRAWINGS

These and other aspects, features and advantages of which embodiments of the invention are capable of will be apparent and elucidated from the following description of embodiments of the present invention, reference being made to the accompanying drawings, in which:

FIG. 1 is a front view of a closed cap wax-based applicator of the present invention.

FIG. 2 is a front view of an open cap wax-based applicator of the present invention.

FIG. 3 is a perspective view of the wax-based applicator of the present invention when in use on a surface of a material.

FIG. 4 is a perspective view of the wax-based applicator of the present invention being applied to laces.

### DESCRIPTION OF EMBODIMENTS

Specific embodiments of the invention will now be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements. While different embodiments are described, features of each embodiment can be used interchangeably with other described embodiments. In other words, any of the features of each of the embodiments can be mixed and matched with each other, and embodiments should not necessarily be rigidly interpreted to only include the features shown or described.

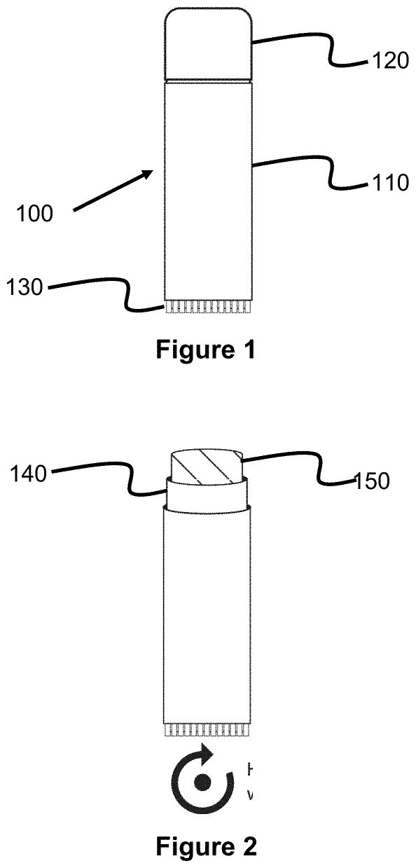

Referring initially to FIG. 1, a wax-based applicator 100 of the present invention generally includes a cylindrical body 110. A removable cap 120 is positioned on the top portion of the cylindrical body 110 and a swivel base 130 is positioned at the bottom of the cylindrical body 110. Without limiting the shape of the body 110 of the applicator 100 to be cylindrical, it should be known that the body 110 of the applicator 100 can be of any shape.

As can be seen in FIG. 2, the cylindrical body 110 of the wax-based applicator 100 comprises an inner chamber 140. FIG. 2 further shows that a wax-based stick 150 protrudes from the inner chamber 140 of the cylindrical body 110 of the wax-based applicator 100.

The swivel base 130 positioned at the bottom of the cylindrical body 110 may be twisted with fingers in a clockwise fashion to protrude the wax-based stick 150 from the inner chamber 140 of the cylindrical body 110.

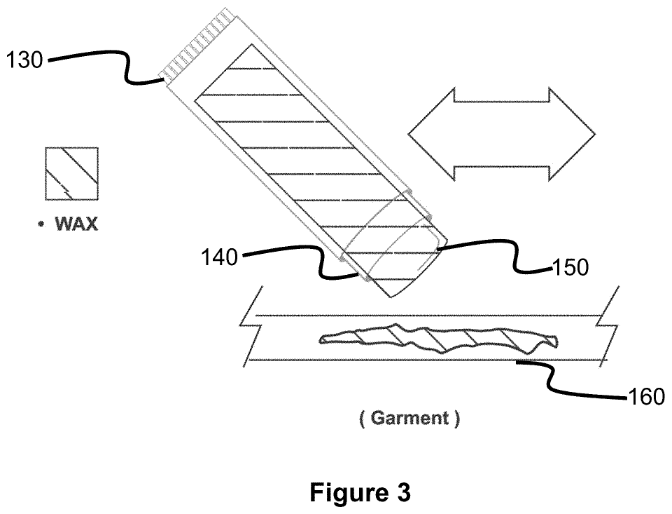

The wax-based stick 150 may be rubbed on the surface 160 of the shoe and boot laces, as shown in FIG. 3, to increase the friction and gription of said surface 160.

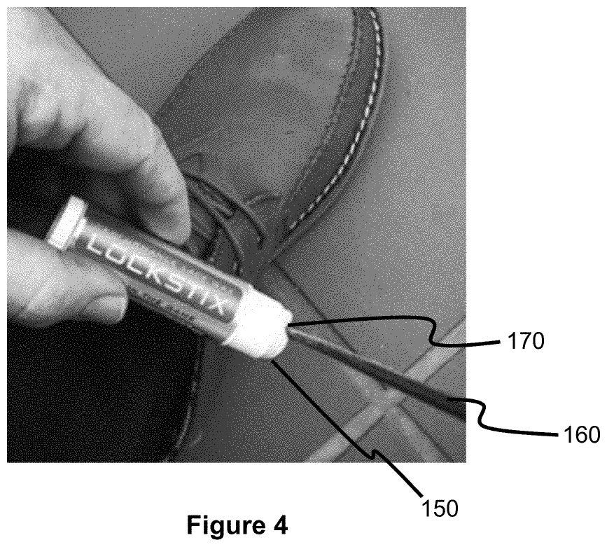

As can be seen in FIG. 4, the wax-based compound of the applicator 100 forms a groove 170 on the top of the stick 150 through use. The groove 170 allows the coverage of the surfaces to be applied to increase and surrounds both sides of the bootlace surfaces 160.

In some embodiments, the wax-based compound comprising the stick 150 increases the surface friction of the shoe and boot laces when the wax compound is rubbed on those surfaces. The increase in surface friction prevents the stretching and relaxing of the knots of the shoelaces and help the knots remain stationary in response to the combined impact of the force of the user's foot striking the ground and the motion of user's leg on the ground. The compound comprising the stick 150 increases the stiction of the surfaces in contact, which is defined as the static friction that needs to be overcome to enable relative motion of stationary objects which are in contact with each other. The compound comprising the stick 150 also increases the gription, the property of gripping and providing traction, of the surfaces in contact.

According to some embodiments, the wax-based compound of the applicator 100 assists to increase friction on the surfaces of footwear, garments, and sports equipment in addition to shoe and boot laces under all types of conditions and climates, for example, under rainy, snowy, and muddy conditions. In some embodiments, the wax-based compound of the applicator 100 may be used for winter apparel, water sports, mountain sports, hunting and fishing equipment. In some embodiments, the wax-based compound of the applicator 100 may be applied to zipper. According to some embodiments, the wax-based compound increases the friction on the surfaces of the zipper to keep it from opening under very cold temperature.

In some embodiments, the wax-based compound of the applicator 100 functions as a water and moisture repellant and provides water or moisture proofing surface of the garments by creating a coating of the wax on the surfaces of the garments.

In some embodiments, the wax-based compound of the applicator 100 provides a bitter taste and or odor to the shoelaces and bootlaces and deter pets from chewing the shoelaces and bootlaces.

According to some embodiments, the wax-based compound of the applicator 100 is formulated by using nontoxic, odorless, organic compounds comprising beeswax, and other natural ingredients, for example, natural oils such as coconut oil and vegetable oil. In some embodiments, the wax-based compound of the applicator 100 may also include tree rosin. According to some embodiments, the wax-based compound optionally comprises non-organic additives such as carnauba wax, and paraffin wax.

**According to some embodiments, the wax-based compound of the applicator 100 is formulated to prevent pets from chewing the shoelaces or bootlaces. In some embodiments, the anti-chewing formula comprises beeswax, vegetable oil, and bitter apple extract in a ratio of 3:1:1 by volume. According to some embodiments, the anti-chewing formula further comprises cayenne pepper. The composition of the wax-based compound is organic and fully environmentally safe to use and apply on different surfaces.

In some embodiments, the wax-based compound function as a moisture and water repellant. The wax-based compound of the applicator 100 does not need heating to function as a water or moisture repellant or increase the friction and gription of the surfaces onto which it is applied.

The wax-based compound of the applicator 100 may be applied directly to footwear, shoelaces, bootlaces, garments and both indoor and outdoor sports equipment, water sports and mountain sports equipment, athletics, hunting and farming equipment. Without limiting the use of the wax-based compound of the applicator 100 to the above equipment surfaces, it can be used for all possible indoor and outdoor surfaces to increase the friction and gription of the surfaces or make the surfaces water or moisture repellant.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A handheld applicator for shoelaces comprising:
a wax-based compound including:
beeswax; and,
coconut oil;
wherein said wax-based compound increases friction and gription of surfaces of said shoelaces when applied thereto.

2. The handheld applicator of claim 1, wherein said wax-based compound comprises a ratio of 3:1 by volume of beeswax and coconut oil.

3. The handheld applicator of claim 1, wherein said wax-based compound comprises non-organic additives.

4. The handheld applicator of claim 3, wherein said non-organic additives include carnauba wax.

5. The handheld applicator of claim 3, wherein said non-organic additives include paraffin wax.

6. A method of preventing shoelaces from becoming untied comprising:
providing a wax-based substance in a hand-held applicator;
rubbing said wax-based substance onto surfaces of said shoelaces to form a coating; and
tying said shoelaces into a knot located at said surfaces, whereby said wax-based substance increases friction and gription of the surfaces of the knot.

7. The method of claim 6, wherein the step of rubbing said wax-based substance onto surfaces of said shoelaces to form a coating comprises turning a base of said applicator to expose a portion of said wax-based substance out of an end of said applicator.

8. The method of claim 6, wherein said wax-based substance comprises beeswax and coconut oil in a ratio of 3:1 by volume.

9. The method of claim 6, wherein said wax-based substance comprises non-organic additives.

10. The method of claim 9, wherein said non-organic additives comprise carnauba wax.

11. The method of claim 9, wherein said non-organic additives comprise paraffin wax.

12. The method of claim 6, wherein the step of rubbing said wax-based substance onto surfaces of said shoelaces further comprises providing a bitter taste to said surfaces of said shoelaces.

13. The method of claim 12, wherein the step of rubbing said wax-based substance onto surfaces of said shoelaces further comprises providing said bitter taste to said surface of said shoelaces wherein said wax-based substance comprising a formulation of beeswax, vegetable oil and bitter apple extract in a ratio of 3:1:1 by volume.

14. A handheld applicator for shoelaces comprising:
a body having an inner chamber,
a removable cap attached to a top portion of said body, and
a swivel base attached to a bottom portion of said body;
wherein said inner chamber of said body further includes:
a wax-based compound comprising:
beeswax,
vegetable oils, and
bitter apple extract
wherein said wax-based compound deters pets from chewing said shoelaces.

15. The handheld applicator of claim 14, wherein said wax-based compound comprises a ratio of 3:1:1 by volume of beeswax, vegetable oil and bitter apple extract.

16. The handheld applicator of claim 14, wherein said wax-based compound further comprises cayenne pepper.

17. The handheld applicator of claim 14, wherein said wax-based compound further increases friction and gription of surfaces of said shoelaces when applied thereto.

18. The handheld applicator of claim 1, wherein said wax-based compound repels water.
